(19) United States
(12) Patent Application Publication
(10) Pub. No.: US 2017/0352101 A1
(43) Pub. Date: Dec. 7, 2017

(54) Insurance rating computer system and computer-implemented method

(71) Applicant: KERMOBILE SOLUTIONS, Paris (FR)

(72) Inventors: Evrard DE VILLENEUVE, Paris (FR); Lara LE PERU, Paris (FR); Bruno DE TERLINE, Paris (FR); Karl RICHTER, Boulogne Billancourt (FR)

(21) Appl. No.: 15/173,452

(22) Filed: Jun. 3, 2016

(51) Int. Cl. G06Q 40/08

(52) U.S. Cl. CPC G06Q 40/08

(57) ABSTRACT

A computer-implemented rating system. An operations server defines a schedule of tasks to be performed on the equipment. An operator terminal capable of remote communications with the operations server and transmits operation-related data to the server. A damages server capable of communications with the operations server and for attributing a damage type identifier to a recognized disorder and an identifier of an originator probably liable for the damage, generates corresponding damage claims. An insurance server capable of communications with the damages server and receives damage claims. A rating engine for rating the operator, the originators and the insurance company based on damage estimation by operator, damages server and insurance company input. The system applies to insurance management in connection with at least one operator on equipment obtained by a plurality of equipment originators and an insurance company providing insurance for the equipment.

### FIELD OF THE DISCLOSURE

The present invention relates to methods and systems for rating stakeholders upon occurrence of damages in the exploitation of equipment (buildings, transportation equipment, industrial premises, etc.) covered by insurance policies.

### BACKGROUND OF THE DISCLOSURE

The construction of a property or other equipment is generally subject to warranties after delivery (warranty of fitness/habitability). Thus when damages occur in the years following delivery, the liability of building contractors such as architects, masons, electrical enterprises, painters, etc., and more generally of originators of an equipment, can be involved. This liability is often covered by an insurance policy, in such way that the cost of repairs, e.g. to consolidate a building or bring it back to a state suitable for use, are covered by the insurance company. This insurance policy implies that the insured entity pays a premium to insurance company, the amount of this premium being calculated by insurance company as a function of the damage occurrence risks.

These risks are usually calculated by the building contractors by taking into account the following criteria:
damage claim antecedents,
insurance antecedents: terminations, payment failures, periods of time without insurance coverage,
turnover and related financial information
staff figures,
   type of activity, and corresponding dangerousness and risk exposure,
the extent and duration of warranties.

The amount of premium or fee is often subject to tenders by clients. To this end, insurance comparators such as www.comparethemarket.com® or www.gocompare.com® can assist the clients in selecting their insurance company.

However, it is difficult to directly compare the risks and the contacts, despite improvements or finer categorizations of the insurance criteria. In addition, the execution of the contracts, their renewal and the initial selection of the companies that answer the call for tenders can vary. At the end, the gap between the actual risk and the risk actual coverage can be large. The insured entities are exposed to the payment of a premium which is too high in regard of the actual risk coverage, or the insurance companies receive a premium which is insufficient in regard of the risk they cover.

### SUMMARY OF THE INVENTION

The present invention aims at providing a computer system and a computer-implemented methods involving servers and terminals at different levels of the chain, that allow reducing such gaps.

To this end, the present invention provides according to a first aspect a computer implemented rating system for insurance management in connection with at least one operator on an equipment obtained by a plurality of equipment originators and an insurance company providing insurance for said equipment, comprising:
an operations server defining a schedule of tasks to be performed on said equipment,
an operator terminal capable of remote communications with said operations server and of transmitting to said operations server operation-related data,
a damages server capable of communications with said operations server and comprising means capable, in response to a recognized disorder, for attributing to the disorder a damage type identifier and an identifier of an originator probably liable for the damage, and means for generating corresponding damage claims,
an insurance server capable of communications with said damages server and configured to receive damage claims,
a rating engine for rating said operator, said originators and said insurance company based on damage estimation by operator input, by damages server and by insurance company input.

Preferred but non limiting aspects of this system comprises the following features, taken individually or in any technically compatible combinations:
said damages server comprises means for recognizing disorders from said operation-related data.
said operation-related data comprise pictures taken with a camera of said operator terminal before and after a task is performed.
said operation-related data comprise geolocation information concerning task performance generated in said operator terminal.
said operation-related data comprise time-stamping information concerning task performance generated in said operator terminal.
said operation-related data comprise encumbrance levels of an equipment part to be cleaned, said encumbrance levels being derived from an error rate in a reading operation of a machine-readable code provided on said part by a code reader of said operator terminal.
said operation-related data comprise camera axis data of said operator terminal associated with pictures taken.
the system further comprises an equipment information model accessible by said operations server and said damages server.
said damages server is configured to locate a disorder by applying said geolocation information to said equipment information model.
said damages server is configured to locate a damage by further applying camera axis data to said equipment information model.
said operations is capable of deriving probable operator liability of a recognized disorder as a function of the location of said disorder in said equipment information model.
said means for recognizing disorders comprise an image analysis program capable of analyzing pictures taken by said operator terminal camera.
said damage estimation comprises a damage amount and a liability level.
said liability level comprises a distribution of liabilities among a plurality of damage originators.
said rating engine is configured to compute dispute rates.
said rating engine is configured to compute responsiveness rates of operator(s), originators and insurance company.
said rating engine is configured to compute gaps between damage estimations by at least two estimators in a group comprising an operator, an originator, an insurance company, an insurance expert and a court.
said rating engine is configured to compute damage-specific gaps.
said rating engine is configured to compute originator-specific gaps.
said rating engine is configured to compute insurance company-specific gaps.
said operator is an equipment maintenance operator, and said equipment is a real estate property.

According to a second aspect, the present invention provides a computer-implemented rating method for insurance management in connection with at least one operator on an equipment obtained by a plurality of equipment originators and an insurance company providing insurance for said equipment, comprising the following steps:
providing at an operations server a schedule of tasks to be performed on said equipment,
providing task guidance on an operator terminal capable of remote communications with said operations server;
generating at said operator terminal operation-related data and transmitting said data to said operations server,
at a damages server capable of communications with said operation server, and attributing to a recognized disorder a damage type identifier and an identifier of an originator probably liable for the damage
transmitting a corresponding damage claim to an insurance server, and
performing rating computation for rating said operator, said originators and said insurance company based on damage estimation by operator input, by damages server and by insurance company input.

Preferred but non limiting aspects of this method comprises the following features, taken individually or in any technically compatible combinations:
the method further comprises a step of recognizing disorders from said operation-related data at said damages server.
the method further comprises a step of taking pictures with a camera of said operator terminal before and after a task is performed, said pictures being included in said operation-related data.
the method further comprises a step of generating geolocation information in said operator terminal during task execution and including said geolocation information in said operation-related data.
the method further comprises a step of generating time stamps in said operator terminal during task execution and including said time stamps in said operation-related data.
the method further comprises a step of determining an encumbrance level of an equipment part to be cleaned from an error rate in a reading operation of a machine-readable code provided on said part by a code reader of said operator terminal, and including said encumbrance level in said operation-related data.
the method further comprises a step of determining a camera axis in said operator terminal while a picture is taken and including camera axis information in said operation-related data.
the method further comprises locating a damage by applying said geolocation information to an equipment information model.
said damage is located by further applying camera axis data to said equipment information model.
the method further comprises a step of deriving probable operator liability of a recognized disorder as a function of the location of said disorder in said equipment information model.
said disorder recognition step comprises performing image analysis on pictures taken by said operator terminal camera.
said damage estimation comprises a damage amount and a liability level.
said liability level comprises a distribution of liabilities among a plurality of damage originators.
said rating computation step comprises the computation of dispute rates.
said rating computation step comprises the computation of responsiveness rates of operator(s), originators and insurance company.
said rating computation step comprises the computation of gaps between damage estimations by at least two estimators in a group comprising an operator, an originator, an insurance company, an insurance expert and a court.
said rating computation step comprises the computation of damage-specific gaps.
said rating computation step comprises the computation of originator-specific gaps.
said rating computation step comprises the computation of insurance company-specific gaps.
said operator is an equipment maintenance operator and said equipment is a real estate property.

### BRIEF DESCRIPTION OF THE DRAWINGS

Other features, aims and advantages of the present invention will better appear from the following description of preferred embodiments thereof, given by way of non limiting example and with reference to the appended drawings, in which:

FIG. 1 diagrammatically shows a computer system for implementing the present invention,

FIG. 2 illustrates a maintenance method according to the present invention,

FIG. 3 illustrates an incident or damage handling method according to the present invention,

FIG. 5 illustrates an operation method according to the present invention,

FIG. 4 illustrates a liability record generation method according to the present invention,

FIG. 6 illustrates a damage handling method according to the present invention,

FIG. 7 illustrates a damage claim handling method according to the present invention, and

FIG. 8 illustrates a rating method according to the present invention.

### DETAILED DESCRIPTION OF A PREFERRED EMBODIMENT

A computer-implemented rating method and system according to the present invention, involving in an insurance database, will now be described.

It should be noted here that the same reference numerals will be used in the following for a particular information storage area or register, for the nature of the information stored therein and for the value of such information.

In addition, the same reference numeral shall be used for different instances of variables or data sets. For instance, two different property identifiers for respective building information models 134 will be designated by the same reference numeral 1341.

### 1) Computer System

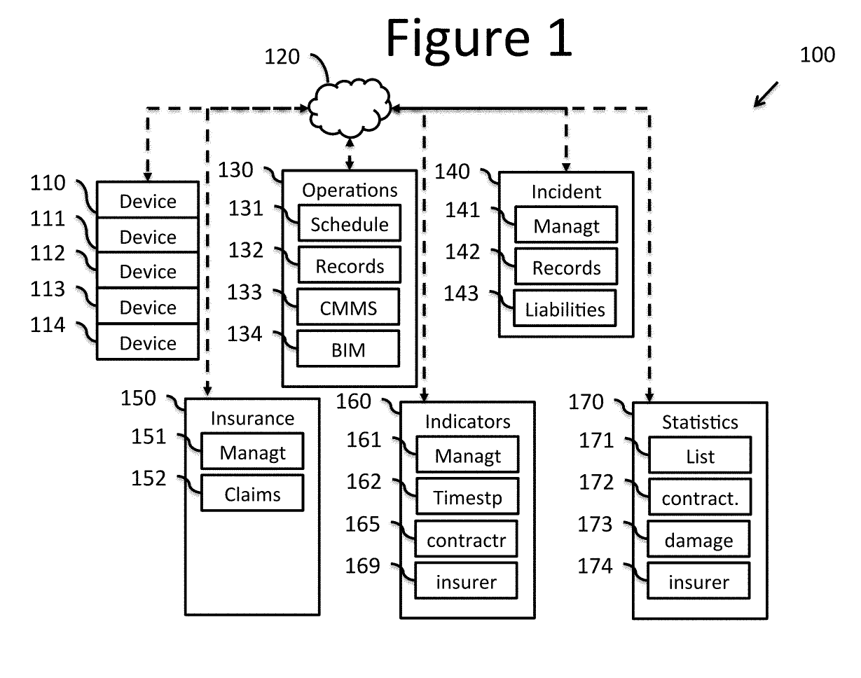

FIG. 1 diagrammatically shows a computer system 100 implementing a preferred method of the present invention.

Computer system 100 comprises a set of terminals 110-114 capable of accessing computer servers 130, 140, 150, 160, 170 via a computer network 120 such as the Internet. Each terminal and each server comprise processing means for executing programs and storage means for storing data, and communications circuits for handling communications between servers and terminal according to appropriate protocols such as HTML, FTP, SMS, email, collaborative software, etc.

Reference 130 designates an operations server containing schedules 131, construction or maintenance records 132, an operations management module 133 and a modeling module 134.

The present description will practically deal with the case of operations of maintenance of gutters in a group of buildings. In this case the maintenance server 130 stores maintenance schedules 131, maintenance notes 132, a computerized maintenance management (CMM) module 133 and a building information model (BIM) 134.

A maintenance schedule 131 contains a list of maintenance operations to be performed according to a specific timetable. Thus the maintenance agent must clear the gutters of a group of building at regular intervals to avoid that dead leaves accumulating therein cause obstruction and a water disorder.

A maintenance schedule 131 is associated to a property identifier 1311 and is characterized in particular by a defined frequency of cleaning actions (or number of actions per time unit), stored at 1312.

A maintenance record 132 details each visit made according to the maintenance schedule 131. Each generated record 132 contains an identifier 1321 of the maintenance company, an identifier 1322 of the visit schedule to be followed by the maintenance agent, data 1323 representative of the locations where cleaning should be performed, e.g. the gutter ends. It can additionally contain pictures 1326 taken by the maintenance agent before the operation and pictures 1327 taken after the operation, as well as geolocation data 1324 and timestamp data 1325 of these pictures, data 1332 proving the performance of maintenance operation and maintenance reports 1331.

The maintenance schedule 131 and the notes 132 are generated by CMM module 133. This module is based on a CMMS (Computerized Maintenance Management System) software package that maintains a computer database of information about maintenance operations in an organization. Preventive maintenance tends to follow planned guidelines from time-to-time to prevent equipment and machinery breakdown. The care and servicing by personnel for the purpose of maintaining equipment and facilities in satisfactory operating condition tends to provide systematic inspection, detection, and correction of incipient failures either before they occur or before they develop into major defects.

CMM module 133 cooperates with BIM module 134, which for instance is a software package commercially available as FM:Interact®, co-developed by FM:Systems® et Autodesk®.

CMM module 133 is capable of generating a proof of passage, stored at 1332, by applying the following rule: the proof of passage 1332 is validated only if the geolocation 1324 of the picture 1327 taken after the operation complies to the one provided in maintenance schedule 131.

CMM Module 133 can be configured to measure the encumbrance level of the gutters, stored at 1335, 1336. For this purpose, CMM module 133 contains a QR-Code interpretation program, known per se to the skilled person. In this regard, the QR-Code standard provides a certain level of redundancy, typically of the Reed-Solomon type, in order that a code can still be read even when strongly deteriorated. The QR-Code interpretation program is thus capable of measuring an read error rate which is proportional to the degradation of the code. In the present application, QR-Codes of appropriate size are painted or printed in the gutters of the buildings to be maintained and captured by the maintenance agent. As the gutters are more or less covered with dead leaves, the reading of the QR-Code provides a more or less important error rate. Thus module 133 is capable of measuring the degree of encumbrance of the gutters by using the error rate of the QR-Code reading caused by the presence of leaves on pictures 1326, 1327. This degree of encumbrance is stored at 1335, 1336. Of course other technical means can be used to determine the encumbrance level of the gutters, such as color and/or reflection based image recognition, etc.

The CMM module 133 can further compute the task duration 1333 by difference between the timestamps of pictures 1326 and 1327.

The CMM module 133 is also capable of generating a maintenance report 1331 that synthetizes in an appropriate format the set of data 1332, 1333, 16552 relating to the corresponding maintenance record 132.

Operations server 130 contains a building information modeling (BIM) program 134. A BIM is a digital representation of physical and functional characteristics of a facility. A BIM is a shared knowledge resource for information about a facility forming a reliable basis for decisions during its life cycle. It carries all information related to the building, including its physical and functional characteristics and project life cycle information, in a series of “smart objects”. For example, an air conditioning unit within a BIM would also contain data about its supplier, operation and maintenance procedures. Throughout the construction period, the project team must continuously update the BIM model so that it reflects the most up-to-date information which later on can be used by the facility managers for building operations and maintenance. This makes it very simple for a maintenance worker to access the required information vital to different systems in the building. The advances in smartphones and tablet devices (such as iPhone® and iPAD®) and Augmented Reality (AR) 1343 has made it possible to obtain complete information about a building component by just pointing the device towards it (AZHAR, Salman; KHALFAN, Malik; MAQSOOD, Tayyab. “Building information modelling (BIM): now and beyond”, Construction Economics and Building, [S.I.], v. 12, n. 4, p. 15-28, oct. 2015. ISSN 2204-9029). Information requirements can be identified and flow can be established. Identifying the necessary information and establishing flow of information is an important part of improving the contractor's work.

The BIM program 134 stores in particular property identifiers 1341 and their geolocations 1342.

Incident and damage server 140 contains a management module 141, a database 142 of incident records, and a database 143 of liability records.

Management module 141 further contains a disorder recognition program 1411 that is capable of identifying a disorder type 1423, of establishing a proof 1425 of a disorder that affects a property based on geolocalized pictures 1424 which the program interprets in cooperation with building information model 134.

Such program is for instance of the type developed by the Fraunhofer Institute for Industrial Mathematics. The researchers have extracted metrics from photographs that include the characteristically elongated shape of a hairline crack, the typical discoloration in damp places, and the structures of the material, which are different for a concrete than for a steel bridge. When the researchers load a photo into the program, the program compares the features of the new image with those of the saved images. If it detects any irregularities, it marks the respective area on the picture. Article “Accelerated Bridge Construction: Best Practices and Techniques”, Mohiuddin Ali Khan Elsevier, 2014 describes such program.

Management module 141 contains a cost estimation program 1412 that cooperates with building information model 134. It is possible to develop detailed cost plans through linking a ‘5D Cost Library’ to BIM, which performs the function of an estimating database. A ‘master’ library can be formed, in addition to several project specific variation libraries, making the process highly productive and easily repeatable (VICO Software, 2012). This allows varying levels of detail to be applied to estimates, depending on the project stage (cf. “Advantages and Challenges of Using BIM: a Cost Consultant's Perspective”, Niraj Thurairajah and Dan Goucher, Associated Schools of Construction, 2013). For instance, if a disorder picture 1424 shows a stain on an outside wall, this program 1412 can deduct by image analysis the need for replacement of the wall coating in a rectangular area encompassing this stain. The program then estimates the amount required for repairing the damages and writes it into register 1432.

Incident or damage records 142 allow operators to notify and follow up disorders. Each record 142 is characterized by a property identifier 1421, an incident or damage type 1423 represented by a reference in list 171, pictures 1424 of disorders, proofs 1425 of disorders, incident or damage diagnostic reports 1426, a record validation button 1427 and insurance claim data 1428.

Liability records 143 allow allocating the liability of a damage to a contractor or to split it between a plurality of contractors. Each record is characterized by a liability distribution 1431, an estimate 1432 of the amount of damages connected to an incident or damage, and validation buttons 1433-1436 for validation by the various contractors and operators.

Insurance server 150 contains a management module 151 and a database 152 of damage claims.

Indicators server 160 contains a management module 161, a time-stamping module 162 for time-stamping the claim declaration methods 300 or the claim handling methods 400, contractor-specific indicator records 165 and insurance company-specific indicator records 169.

A contractor record 165 is characterized by a contractor type 1652 (maintenance company, architect, tiler, mason, etc.), a database damage amounts 1653 and liability levels 1654, ratios concerning the contractor performance (efficiency ratio 1655, schedule compliance ratio 1656), ratios concerning incidents and insurance (damage risk 1657 and responsiveness 1658), and notes 1659.

An insurance company record 169 contains indicators 1691-1699 of the company's activity.

Statistics server 170 contains a list 171 of damages, a database 172 of liability statistics by contractor type, a database 173 of liability statistics by damage type and a database 174 of liability statistics by insurance company.

Damages list 171 is a tree-structure of references with different accuracy levels, e.g. as follows:
1711—theft
1712—fire
1713—water damage
17131—wall seepage
17132—drain overflow or backflow
17133—pipe leak or rupture
17134—roof, terrace or upper floor seepage
171341—roof
1713411—gutter
171342—upper floor
1713421—sanitary facilities
17134211—seals/gaskets

Database 172 of liability statistics by contractor type stores records 1721 of maintenance companies, records 1722-1724 of other contractor types and records 1729 of operators.

Database 173 of liability statistics by damage type contains statistics 1731 concerning a first reference (in this example 1713411 for a gutter) of damage list 171 and statistics 1732-1734 concerning other references (in this case three other references) of the list 171.

Database 174 of insurance statistics, common to all insurance companies, contains a database 1741 of statistics concerning reference 1713411 of list 171 and databases 1742-1744 concerning in this case said three other references of the list 171.

### 2) Maintenance Management Method

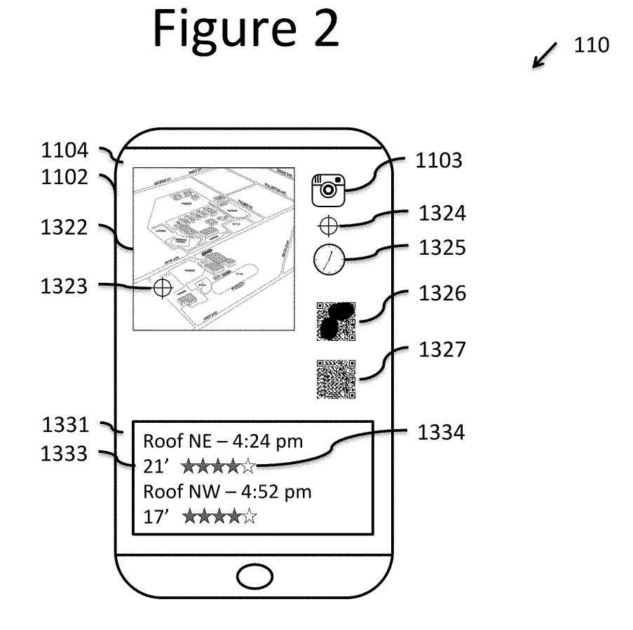

Referring to FIG. 2, terminal 110 is a smartphone allowing a maintenance agent to access maintenance server 130 via a user interface 1104. Upon invitation from the visit schedule 1322, the maintenance agent can take a picture of a QR-Code by means of smartphone camera 1103. Pictures are taken before and after the maintenance operation, so that it can be deducted that dead leaves that partially or totally covered the QR-Code before the maintenance operation have been swept off. Geolocation and timestamp information as provided by GPS unit 1102 and clock of smartphone 110 are associated to picture 1326 before maintenance and picture 1327 after maintenance. The maintenance report completes itself progressively as the visit progresses, the duration 1333 of each task provided in the visit schedule information 1322 and a corresponding performance ratio 16552 being recorded into the report.

### 3) Incident or Damage Management Method

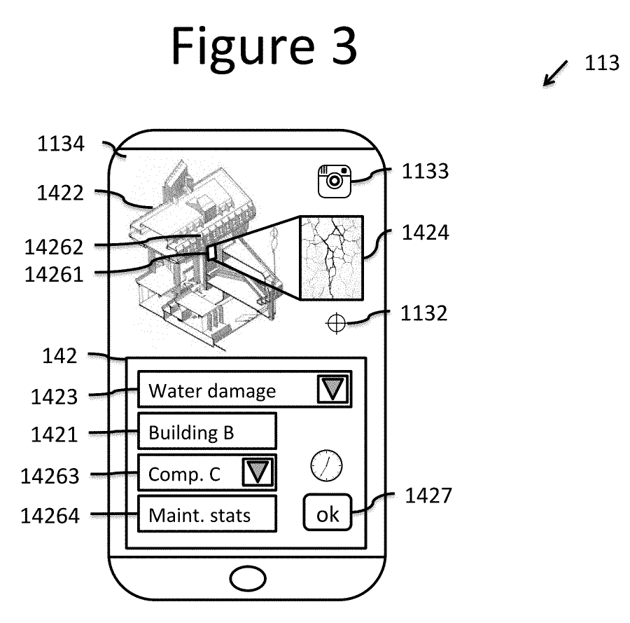

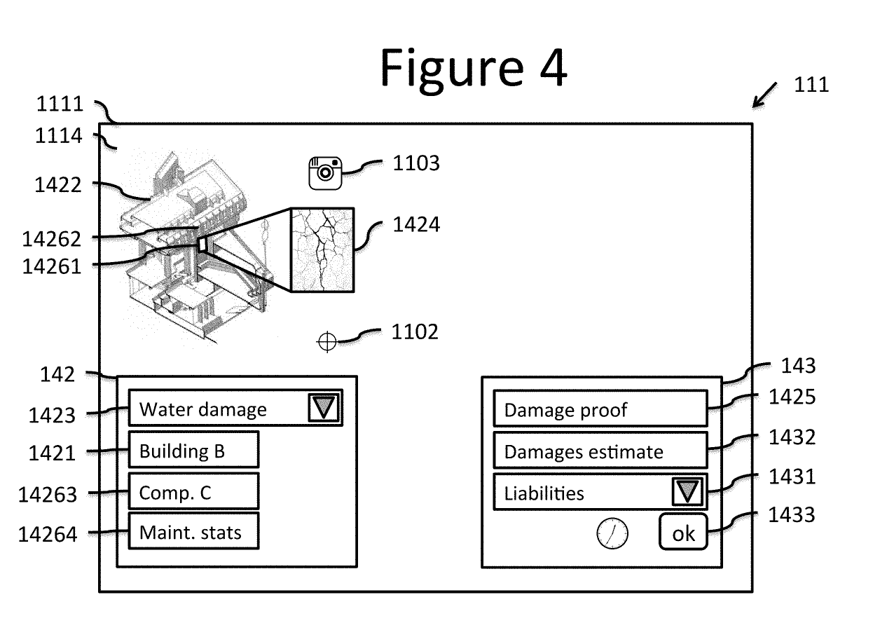

Now referring to FIG. 3, terminal 113 is in the present example a smartphone allowing a first agent of the operator to access the incident and damage server 140 via the Internet 120. Interface 1134 allows the generation of an incident record 142.

Through matching between the geolocation provided by the GPS unit 1132 of smartphone and the geolocation 1342 stored in the building information model 134, management module 141 can pre-fill the property identifier 1421 by copying and pasting item 1341. By means of camera 1133 of smartphone 113, the agent can take pictures of the disorders 1424 for illustrating the incident, e.g. a stain on a wall which reveals water seepage.

By combining the geolocation provided by GPS unit 1132 and the 3D orientation of the camera, provided in a manner known per se by a gyroscope unit 1135 of smartphone 113, management module 141 can compute the locations 14261 of the disorder pictures 1424 and locate them on the building information model 134. For this purpose, module 141 cooperates with the augmented reality component 1343 of building information model 134.

By image analysis of the disorder pictures 1424, the disorder recognition unit 1411 can determine the type 1423 of incident or damage.

Once an incident or damage type 1423 has been determined, e.g. a water damage, and based on information of proximity of these locations 14261 with water ducts as referenced in building information model 134, management module 141 can compute the most probable origin 14262 of leak, in the present example a gutter.

By correspondence of this most probable origin 14262 with the property identifiers 1421 then 1311 in maintenance server 130, management module 141 can retrieve the identifier 1321 of the maintenance company in charge of maintaining of the gutter, and this identifier is copied and pasted into the register 14263 identifying the allegedly liable company.

By correspondence between this probable origin 14262 with contractor identifier 1321, management module 141 also copies and pastes into register 14264 the performance indicators 1655, 1656 and the insurance ratios 1657, 1658 concerning this contractor identifier 1321, and generate therein a link to the maintenance reports 1331.

It should be noted here that in addition or as a substitution of the computer-implemented disorder recognition, disorders can also be recognized by human inspection of data, esp. picture data, originating from agent's terminal 113.

### 4) Liability Record Generation Method

Referring to FIG. 4, terminal 111 is in the present example an personal computer allowing a second agent of the operator to access incident record 142. User interface 1114 displayed on screen 1111 of terminal 111 allows the agent to visualize a liability record 143. This record is generated and pre-filled by management module 141, which copies and pastes the identifier 14263 of the supposedly liable company (or several identifiers of several companies) into liability register(s) 1431, establishes a damage proof 1425 by means of disorder recognition module 1411, and estimates the cost 1432 of repair by means of module 1412. This second agent of the operator can validate this liability record 143 by actuating validation button 1433 after having modified if needed the pre-filled data.

### 5) Operating Method

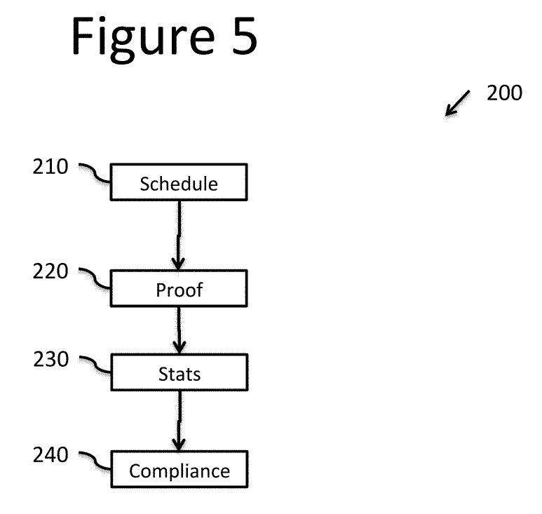

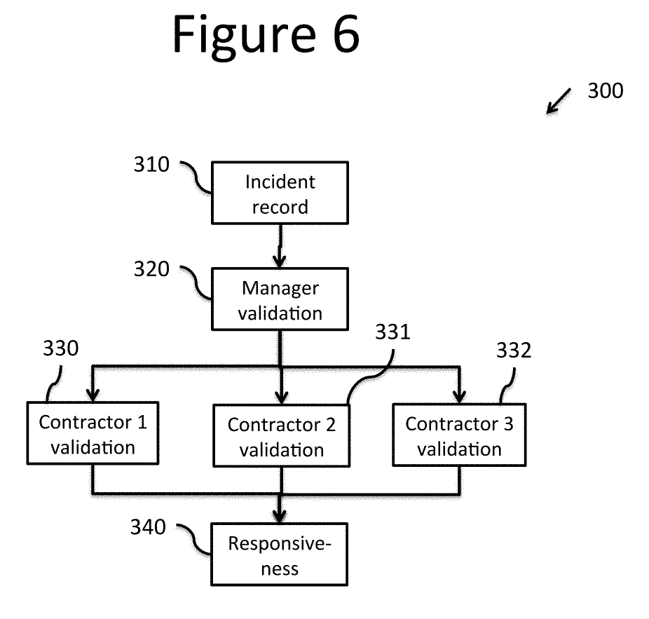

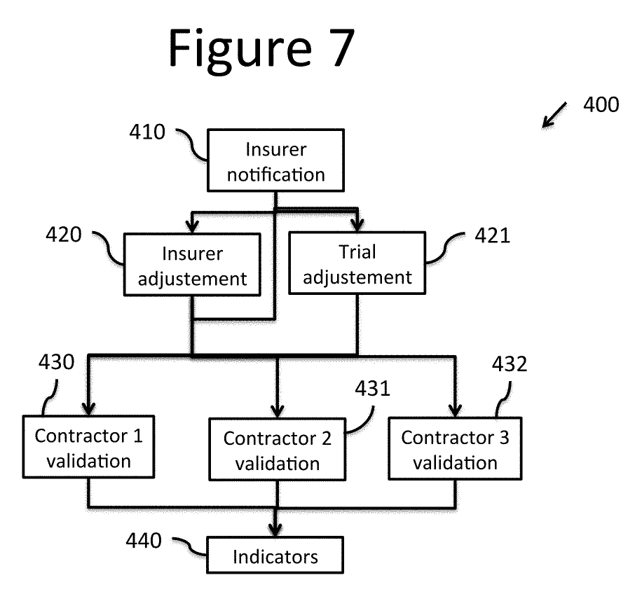

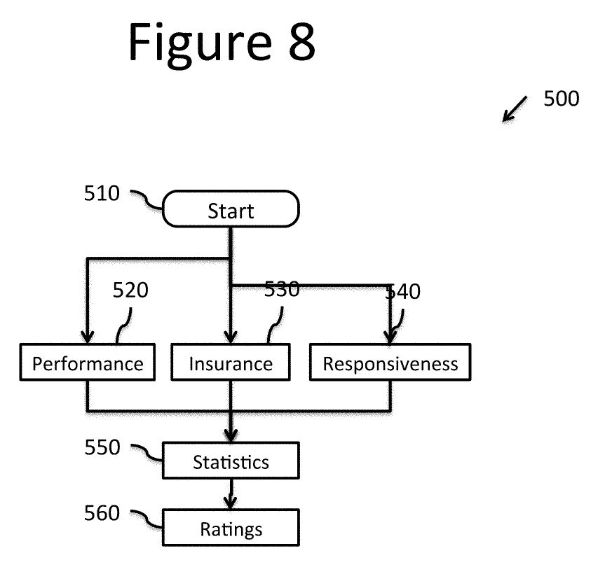

FIG. 5 shows an operating method 200 performed by a contractor agent. This operation comprises a set of building or maintenance actions in a property, as defined in predefined schedule 131. In the present particular example, the operating method 200 is an operation of maintenance of gutters of a group of buildings.

The maintenance agent is equipped with a smartphone 110 which allows him to connect via the Internet 120 to maintenance server 130 and to the maintenance record 132 that corresponds to the date of his visit on site in the maintenance schedule 131.

At step 210, visit schedule 1322 is displayed on display screen 1101 of the maintenance agent smartphone 110. This visit schedule 1322 indicates to agent on a map of the building the passage points 1323, for instance the gutters or downpipes that he has to clean. To these passage points 1323 are associated on-site QR-Codes, e.g. painted inside each gutter of the building.

At step 220, in response to guidance from visit schedule 1322, the maintenance agent takes pictures 1326 before the maintenance operation and pictures 1327 after the maintenance operation, of the QR-Code at the passage point by means of the camera 1103 of his smartphone 110. CMM module 133 generates or supplements maintenance report 1331 with the passage proof data 1332 using the geolocation 1324, the task duration 1333 obtained by the time-stamping 1325, and the encumbrance levels 1335, 1336 of the gutters before and after maintenance. Management module 161 computes a work quality 16551 by difference between encumbrance levels 1335, 1336. CMM module 133 computes a performance ratio 16552 by means of the following formula:

performance 16552=gutter encumbrance level 1335×work quality 16551/task duration 1333.

At step 230, management module 161 computes indicators 16561-16562 concerning the set of maintenance records 132 of the maintenance company, as follows:

visit ratio 16561=number of proofs 1332 of visits/number 1312 of

intended visits in maintenance schedule 131

average performance ratio 16562=mean value of performance ratios

16552

At step 240, management module 161 computes a rate 1656 of compliance with the maintenance schedule 131 according to the formula:

compliance rate 1656=visit ratio 16561×average performance ratio

16562.

### 6) Damage Handling Method

FIG. 6 shows a method 300 for handling an incident or damage.

At step 310, a first agent of the operating company, equipped with a smartphone 113, generates an incident record 142 by means of user interface 1134 and takes pictures 1424 of the disorders by means of the smartphone camera. Management module 141 pre-fills the fields 1421 identifying the property, computes the locations 14261 of the disorder pictures 1424, locates them on the building information model 134, establishes the incident or damage type 1423 and the proof 1425 of the disorders from the geolocated pictures as described above.

At same step 310, management module 141 generates a diagnostic report 1426. For this purpose, it determines the e most probable origin 14262 of the disorders by using the disorders location 14261 and the proof 1425, and determines therefrom the enterprise(s) (contractor(s)) which is/are supposed to be responsible, the identifier thereof being stored at 14263, copies and pastes into register 14264 the performance indicators 1655-1656 and the insurance ratios 16572-1658 of this contractor or these contractors 14263. The incident record 142, as validated by this first agent by actuating validation button 1427, is sent e.g. via email to the predefined terminal 111 of a second agent.

At step 320, terminal 111 of the second operating company agent receives said notification. Management module 141 generates and pre-fills a liability record 143 and more particularly a liability item 1431 and a damage estimation item 1432. Module 141 further copies and pastes into register 14264 performance indicators 1655-1656 and insurance ratios 16572-1658 of contractor(s) 14263. The second agent validates the liability record 143 by actuating a validation button 1433 on the terminal display. Module 141 notifies the validation of this record to the predefined terminal 112 of contractor 14263, e.g. via email transmission.

At step 330, an agent of contractor 14263 is equipped with a terminal such as a PC and accesses via the Internet 120 to an incident and damage server 140 and reads the incident record data 142 and the liability record data 143. Contractor agent validates the damages assessment data 1432 and liability data 1431 by actuating a validation button 1434. This time-stamped validation is also notified to the to management module 161 of server 160, which copies and pastes the damages estimation 1432 into register 1653 of contractor record 165 and its liability level 1431 into register 1654. Management module 161 updates the average damages amount 16571 by computing the average of damages 1653 and updates the average liability 16572 by computing the average of liabilities 1654.

Steps 331 and 441 are triggered if the liability register splits the liabilities between a plurality of contractors. In such case, the additional contractors are invited to validate the damages assessment data 1432 and the liability level data 1431 by actuating respective validation buttons 1435-1436.

At steps 320, 330, 331 and 332, management module 161 stores into time-stamp register 162 the duration of the steps of method 300.

At step 340, management module 161 computes a responsiveness value 1658 for the various contractors. For this purpose, module 161 determines the time difference between the time stamps stored in register 162, thus determining the duration 1621 of each step of method 300; module 161 computes the average 1622 of durations 1621 operator by operator, and the average 1623 of durations for all operators, and determines therefrom a responsiveness value 1658 by taking into account a contractor type data 1652, according to the following formulae:

operator's responsiveness 1658=average of processing durations 1622 of

step 320 for this operator/average of the processing durations 1623 of step

320 for all operators

contractor's responsiveness 1658=average of processing durations 1622

of step 330 for this contractor/average of the processing durations 1623 of

steps 330, 331 and 332 for all contractors.

Management module 161 further updates the average responsivenesses 17216-17226-17296 by contractor and operator type.

### 7) Damage Claim Handling Method

FIG. 7 illustrates a method 400 for handing a damage claim made to insurance company.

At step 410, an agent of operator is provided with a terminal 111 such as a PC. By means of a user interface 1114 and a validation button thereof 1428, a diagnostic report 1426, which is pre-stored in server 140, is declared to the insurance company of operator. Management module 151 copies and pastes this report into register 1521, the estimated damages 1432 into register 15221 and the liability level 1431 into register 15231. Actuating validation button 1428 causes the transmission of an email notifying this declaration 1426 to a predefined terminal 114 such as a PC of insurance company.

At step 420, an insurance company agent, by means of said terminal 114, uses interface 1144 of said terminal to access the diagnostic report 1521, the estimated damages 15221 and the liabilities 15231. By actuating validation button 1527, insurance company agent validates the diagnostic, which causes the copying and pasting of the content of register 15221 into the insurance company's register 15222 of estimated damages and the content of register 15231 into the insurance company's register 15232 of estimated liabilities. The insurance company's agent can alternatively input different values into registers 15222 and 15232 before actuating validation button 1527. This validation causes the transmission of an email notifying this action 15232 to contractor(s).

Step 421 is triggered in case of unsolved disagreement between the parties, giving rise to a dispute. At the end of this step, an agent of the operator, equipped with a terminal 111, inputs the figures from the court decision into the registers 15223 and 15233 of the damages estimate an liabilities, and validates the inputs by actuating button 1528. This validation causes the transmission of an email notifying this action 15233 to insurance company and to contractor(s).

At step 430, contractor validates the estimations 15222, 15232 by insurance company or the amounts 15223, 15233 decided by court, by actuating validation button 1524. This validation causes the transmission of an email notifying this action to the other stakeholders. This transmission is time-stamped and also notified to management module 161 of server 160, which copies and pastes the estimated or decided damages 1432 into register 1653 corresponding to the considered contractor, and its liability level 1431 into register 1654.

Steps 431 and 432 are triggered if the liability registers 15232, 15233 splits the liability between two or more contractors. In such case, the other allegedly liable contractors are invited to validate the estimated damages and liabilities by actuating the respective validation buttons 1525 and 1526.

At steps 410 to 432, management module 161 stores into time-stamping register 162 the duration of each step of method 400.

At step 440, insurance company initiates a bank transfer with amount 1697 for covering damages. Management module 161 establishes the responsivenesses 1658-1698 of the different stakeholders according to the method described at step 340, as well as:
the gap 1691 between the damages estimated by the operator and by the insurance expert by computing the difference between values in registers 15222 and 15221 of the damage claim database 152
the gap 1692 between the damages estimated by the insurance expert and by the court expert by computing the difference between values in registers 15223 and 15333 of the damage claim database 152
the gap 1693 between the liabilities estimated by the operator and by the insurance expert by computing the difference between values in registers 15232 and 15231 of the damage claim database 152
the gap 1694 between the liabilities estimated by the insurance expert and by the court expert by computing the difference between values in registers 15233 and 15232 of the damage claim database 152
the reserve ratio 1695 by computing the quotient of the paid amount 1697 by the amount 15221 of damages estimated by the operator
the dispute ratio 1696 by computing the quotient of the number of triggered steps 421 by the number of methods 400 run, as stored in historical data.

### 8) Rating Method

FIG. 8 illustrates a method 500 for rating stakeholders.

At step 510, method 500 is waiting for the activation of one of the three methods 200, 300 or 400.

At step 520, management module 161 computes the performance indicators 1655, 1656 of the contractors as detailed in the description of method 200.

At step 530, management module 161 computes the insurance indicators 1657, 1658 of the contractors as detailed in the description of method 300.

At step 540, management module 161 computes responsiveness indicators 1658-1698 for contractors and insurance companies, as well as other indicators concerning the insurance companies, as detailed in the description of method 400.

At step 550, management module 161 updates the database 173 of liability statistics by damage type. For this purpose, module 161 looks up in the damage list 171 the reference (1713411 in the present species, for a gutter damage) that corresponds to the incident or damage type 1423. Module 161 then opens the record 1731 corresponding to reference 1713411 and updates the different fields 17311 et seq. as a function of the contractor type 1652 and the following formulae:

total damages(post) 17311=total damages(pre) 17311+estimated

damage 1653

maintenance liability(post) 17312=((maintenance liability(pre) 17312×

total damages(pre) 17311)+(maintenance liability 1654×damages 1653))/total

damages(pre) 17311+damages 1653)
the liability values 17313-17316 for the other contractors are computed using the same formula.

At the same step 550, management module 161 updates the database 172 of liability statistics by contractor type, e.g. the maintenance contractor type 1721, using the following formulae:

number of damages(post) 17211=number of damages(pre)+1

average amount of damages(post) 17212=average amount of damages

(pre)×number of damages(pre)+maintenance liability 1654×damages

1653/number of damages(post) 17211
average percentage 17213 of liabilities for all damage types=mean value of (R17312; R17322; R17332; . . . )
average performance ratio 17214=mean value of the average performance ratios 16562 of all maintenance companies
average compliance rate 17215=mean value of the compliance rates 1656 of all maintenance companies.

At same step 550, management module 161 opens record 1741 of insurance statistics database 174 that corresponds to the above-mentioned particular reference 1713411 (gutter disorder). Management module 161 computes the statistical values and updates the different fields 17411 et seq. by establishing the mean values between all items 1691 et seq. corresponding to this same reference 1713411, as follows:
average gap 17411 between the damages estimated by operator and by insurance expert=mean value of the equivalent gaps 1691 among all insurance companies
average gap 17412 between the damages estimated by insurance expert and by court expert=mean value of the equivalent gaps 1692 among all insurance companies
average gap 17413 between the liabilities estimated by operator and by insurance expert=mean value of the equivalent gaps 1693 among all insurance companies
average gap 17414 between the liabilities estimated by insurance expert and by court expert=mean value of the equivalent gaps 1694 among all insurance companies
average reserve ratio 17415=mean value of the equivalent ratios 1695 among all insurance companies
average dispute rate 17416=mean value of the dispute rates 1696 among all insurance companies
average payment amount 17417=mean value of the equivalent amounts 1697 among all insurance companies
average responsiveness 17418=mean value of the equivalent responsivenesses 1698 among all insurance companies.

At step 560, management module 161 updates the ratings 1659-1699 of the different stakeholders by applying the following formulae:
insurance company rating 16991 for damage type 1713411=mean value of the set of following ratios:
   average gap 17411 between damages estimated by the operator and by the insurance expert/gap 1691 between damages estimated by the operator and by the insurance expert
   gap 1692 between damages estimated by the insurance expert and by the court expert/average gap 17412 between damages estimated by the insurance expert and by the court expert
   average gap 17413 between damages estimated by the insurance expert and by the court expert/gap 1693 between damages estimated by the insurance expert and by the court expert
   gap 1694 between damages estimated by the insurance expert and by the court expert/average gap 17414 between damages estimated by the insurance expert and by the court expert
   reserve ratio 1695/average reserve ratio 17415
   average dispute ratio 17416/dispute ratio 1696
   payment amount 1697/average payment amount 17417
   responsiveness 1698/average responsiveness 17418
rating 1699 of insurance company on all damage types=mean value of all ratings (rating 16991 on damage type 1713411, rating 16991 on a second damage type; rating 16993 on a third damage type; . . . )
contractor rating 1659=mean value of all the following ratios:
   average damages amount 17212 for the considered contractor type/average contractor damages level 16571
   average liability level 17213 for the considered contractor type/average contractor liability 16572
   performance ratio 16552/average performance ratio 17214 for the considered contractor type
   compliance ratio 1656/average compliance ratio 17215
   responsiveness 1658/average responsiveness 17216 for the considered contractor type.

### Variations of the Present Invention

a) Ratings 1659-1699 can be computed with different mathematical formulae and can use additional or different indicators. For instance, contractor rating 1659 can be a function of the average damages amount 16571, of the average liability 15572, of the responsiveness rating 1658, or the schedule compliance 1656, of an evolution of the risks, of a frequency of delays over contractual deadlines, of an insurance damage claim declaration rate, of an average number of amendments to declarations, of a frequency of damage claims per surface area unit of the property, etc.

Similarly:
insurance rating 1699 can be a function of payment, risk, responsiveness, coverage, fidelity, permanence,
payment rating can be a function of amount, payment schedule, late payment penalties,
risk rating can be a function of contractor rating, use, property type, Risque=f(note locateur, usage, type de lieu)
responsiveness rating can be a function of administrative reaction time, average,
coverage rating can be a function of damages amount, amount covered, average,
fidelity rating can be a function of the number of insurance claims and contract renewal data,
permanence rating can be a function of first estimate of the amount to be covered and final covered amount,
use can be one among office use, health service use, housing, hotel, etc.
location type can be one among mountain area, seaside area, floodable area, etc.

b) Ratings 1659-1699 can be detailed component by component (average damages amount, average liability, responsiveness, etc.), segment by segment (contractor type, geographical area, etc.) or detail level by detail level (property program, damage type, expert, etc.).

c) Management module 161 can establish rankings of insurance companies, of contractors, of operating companies in decreasing order of their ratings, according to the various categories 1652, 1711, 1712, 1713.

d) In building maintenance applications, the visit locations 1323 can be materialized by QR-Codes affixed to technical cabinets and other equipment, by NFC tags capable of communicating with smartphones, by pictures of disorder and their curing (e.g. an obstructed and de-obstructed siphon), and appropriate image recognition programs for identifying said disorders and their curing.

e) The generation of an incident record 142 at step 310 can be performed automatically in response to detection by a connected equipment (monitoring camera, intrusion sensor, etc.)

f) The proof data 1425 of disorders and their evolution can be generated from a series of pictures of a same location (e.g. propagation of a crack or development of rust over a long period of time), or by interpreting alerts from connected equipment (e.g. frequent boiler failure, unusual temperature variations, etc.).

g) The present invention can be applied to other fields than building construction and maintenance, and in particular:
insurance in construction and maintenance of transportation equipment,
liability insurance in company operation (hidden defects, compliance to standards, personnel safety, pollution, etc.).

1. A computer implemented rating system for insurance management in connection with at least one operator on an equipment obtained by a plurality of equipment originators and an insurance company providing insurance for said equipment, comprising:
an operations server defining a schedule of tasks to be performed on said equipment,
an operator terminal capable of remote communications with said operations server and of transmitting to said operations server operation-related data,
a damages server capable of communications with said operations server and comprising means capable, in response to a recognized disorder, for attributing to the disorder a damage type identifier and an identifier of an originator probably liable for the damage, and means for generating corresponding damage claims,
an insurance server capable of communications with said damages server and configured to receive damage claims,
a rating engine for rating said operator, said originators and said insurance company based on damage estimation by operator input, by damages server and by insurance company input.

2. A system according to claim 1, wherein said damages server comprises means for recognizing disorders from said operation-related data.

3. A system according to claim 1, wherein said operation-related data comprise pictures taken with a camera of said operator terminal before and after a task is performed.

4. A system according to claim 1, wherein said operation-related data comprise geolocation information concerning task performance generated in said operator terminal.

5. A system according to claim 1, wherein said operation-related data comprise time-stamping information concerning task performance generated in said operator terminal.

6. A system according to claim 1, wherein said operation-related data comprise encumbrance levels of an equipment part to be cleaned, said encumbrance levels being derived from an error rate in a reading operation of a machine-readable code provided on said part by a code reader of said operator terminal.

7. A system according to claim 2, wherein said operation-related data comprise camera axis data of said operator terminal associated with pictures taken.

8. A system according to claim 1, further comprising an equipment information model accessible by said operations server and said damages server.

9. A system according to claim 8 wherein said operation-related data comprise geolocation information concerning task performance generated in said operator terminal and said damages server is configured to locate a disorder by applying said geolocation information to said equipment information model.

10. A system according to claim 9 wherein said operation-related data comprise camera axis data of said operator terminal associated with pictures taken and said damages server is configured to locate a damage by further applying camera axis data to said equipment information model.

11. A system according to claim 8, wherein said operations is capable of deriving probable operator liability of a recognized disorder as a function of the location of said disorder in said equipment information model.

12. A system according to claim 2, wherein said means for recognizing disorders comprise an image analysis program capable of analyzing pictures taken by said operator terminal camera.

13. A system according to claim 1, wherein said damage estimation comprises a damage amount and a liability level.

14. A system according to claim 13, wherein said liability level comprises a distribution of liabilities among a plurality of damage originators.

15. A system according to claim 1, wherein said rating engine is configured to compute dispute rates.

16. A system according to claim 1, wherein said rating engine is configured to compute responsiveness rates of operator(s), originators and insurance company.

17. A system according to claim 1, wherein said rating engine is configured to compute gaps between damage estimations by at least two estimators in a group comprising an operator, an originator, an insurance company, an insurance expert and a court.

18. A system according to claim 17, wherein said rating engine is configured to compute damage-specific gaps.

19. A system according to claim 17, wherein said rating engine is configured to compute originator-specific gaps.

20. A system according to claim 17, wherein said rating engine is configured to compute insurance company-specific gaps.

21. A system according to claim 1, wherein said operator is an equipment maintenance operator, and said equipment is a real estate property.

22. A computer-implemented rating method for insurance management in connection with at least one operator on an equipment obtained by a plurality of equipment originators and an insurance company providing insurance for said equipment, comprising the following steps:
providing at an operations server a schedule of tasks to be performed on said equipment,
providing task guidance on an operator terminal capable of remote communications with said operations server;
generating at said operator terminal operation-related data and transmitting said data to said operations server,
at a damages server capable of communications with said operation server, and attributing to a recognized disorder a damage type identifier and an identifier of an originator probably liable for the damage
transmitting a corresponding damage claim to an insurance server, and
performing rating computation for rating said operator, said originators and said insurance company based on damage estimation by operator input, by damages server and by insurance company input.

23. A method according to claim 22, further comprising a step of recognizing disorders from said operation-related data at said damages server.

24. A method according to claim 21, further comprising a step of taking pictures with a camera of said operator terminal before and after a task is performed, said pictures being included in said operation-related data.

25. A method according to claim 22, further comprising a step of generating geolocation information in said operator terminal during task execution and including said geolocation information in said operation-related data.

26. A method according to claim 22, further comprising a step of generating time stamps in said operator terminal during task execution and including said time stamps in said operation-related data.

27. A method according to claim 22, further comprising a step of determining an encumbrance level of an equipment part to be cleaned from an error rate in a reading operation of a machine-readable code provided on said part by a code reader of said operator terminal, and including said encumbrance level in said operation-related data.

28. A method according to claim 24, further comprising a step of determining a camera axis in said operator terminal while a picture is taken and including camera axis information in said operation-related data.

29. A method according to claim 22, further comprising locating a damage by applying said geolocation information to an equipment information model.

30. A method according to claim 29 further comprising a step of determining a camera axis in said operator terminal while a picture is taken and including camera axis information in said operation-related data, wherein said damage is located by further applying camera axis data to said equipment information model.

31. A method according to claim 28, further comprising a step of deriving probable operator liability of a recognized disorder as a function of the location of said disorder in said equipment information model.

32. A method according to claim 22, wherein said disorder recognition step comprises performing image analysis on pictures taken by said operator terminal camera.

33. A method according to claim 22, wherein said damage estimation comprises a damage amount and a liability level.

34. A method according to claim 33, wherein said liability level comprises a distribution of liabilities among a plurality of damage originators.

35. A method according to claim 22, wherein said rating computation step comprises the computation of dispute rates.

36. A method according to claim 22, wherein said rating computation step comprises the computation of responsiveness rates of operator(s), originators and insurance company.

37. A method according to claim 22, wherein said rating computation step comprises the computation of gaps between damage estimations by at least two estimators in a group comprising an operator, an originator, an insurance company, an insurance expert and a court.

38. A method according to claim 37, wherein said rating computation step comprises the computation of damage-specific gaps.

39. A method according to claim 37, wherein said rating computation step comprises the computation of originator-specific gaps.

40. A method according to claim 37, wherein said rating computation step comprises the computation of insurance company-specific gaps.

41. A method according to claim 22, wherein said operator is an equipment maintenance operator and said equipment is a real estate property.
